(19) United States
(12) Patent Application Publication
(10) Pub. No.: US 2002/0171611 A1
(43) Pub. Date: Nov. 21, 2002

(54) Active matrix organic light emitting diode flat-panel display

(75) Inventor: Ronald S. Cok, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/858,109

(22) Filed: May 15, 2001

(51) Int. Cl. G09G 3/32

(52) U.S. Cl. 345/82

(57) ABSTRACT

An active matrix OLED flat-panel display includes a plurality of light emitting elements and associated control circuits; a programmable power supply connected to the control circuits; a sensor for sensing the light output of one or more light emitting elements to produce a feedback signal; and a display controller responsive to the feedback signal for programming the programmable power supply to compensate for changes in the light output from the light emitting elements.

### FIELD OF THE INVENTION

The present invention relates to organic light emitting diode (OLED) flat-panel displays and, more particularly, to means for compensating for aging effects in the light emitting elements of an active matrix flat-panel OLED display.

### BACKGROUND OF THE INVENTION

Organic light emitting diode (OLED) flat-panel display devices are proposed for use in conjunction with computing devices and in particular with portable devices. Over time, the efficiency and effectiveness of the displays changes and the quality of the display, particularly for sensitive applications such as imaging, declines. This decrease in quality is due to changes over time in the materials comprising the display, degradation in electronic components, and the like.

In particular, OLED display devices suffer from changes in the organic light emitting materials within the display. The changes affect the efficiency and brightness of the display. These changes may also be color dependent, that is the changes affect the different colors in the display device in different ways so that over time not only does the power efficiency of the display device decrease, but the color balance changes. These changes can result in an inferior display with poor brightness and color rendition.

In an active matrix type OLED display (as shown in FIG. 1), each light emitting element is individually controlled by an associated control circuit that includes a capacitor 4 that stores a data signal. The capacitor is charged through a transistor 2 connected to data line 1 and a select line 3. A transistor 6 is connected in series with the light emitting element 7 between a power supply 8 and ground. The capacitor is connected to the gate of the transistor to control the current passing through the light emitting element based on the amount of charge stored on the capacitor, thereby determining the brightness of the light emitting element. When the response of the light emitting element to current drops due to aging of the light emitting material, the light emitting element can be recalibrated by increasing the signal stored on the capacitor in the control circuit or by increasing the power supply voltage. In either case intervention is required.

There is a need therefore for an improved method of automatically correcting the brightness and color rendition of an active matrix OLED flat-panel display.

### SUMMARY OF THE INVENTION

The need is met according to the present invention by providing an active matrix OLED flat-panel display that includes a plurality of light emitting elements and associated control circuits; a programmable power supply connected to the control circuits; a sensor for sensing the light output of one or more light emitting elements to produce a feedback signal; and a display controller responsive to the feedback signal for programming the programmable power supply to compensate for changes in the light output from the light emitting elements.

### ADVANTAGES

The present invention has the advantage that it automatically corrects the color balance of a color and brightness of a display system over time, as the materials within the display degrade.

### BRIEF DESCRIPTION OF THE DRAWINGS

FIG. 1 is a schematic circuit diagram showing a prior art active matrix light emitting pixel;

FIG. 2 is a diagram showing an improved voltage controlled display according to the present invention;

FIG. 3 is a diagram showing an improved voltage controlled display with multiple colors according to the present invention; and

FIG. 4 is a diagram showing an improved voltage controlled display with multiple colors integrated into a common substrate or package with the display according to the present invention.

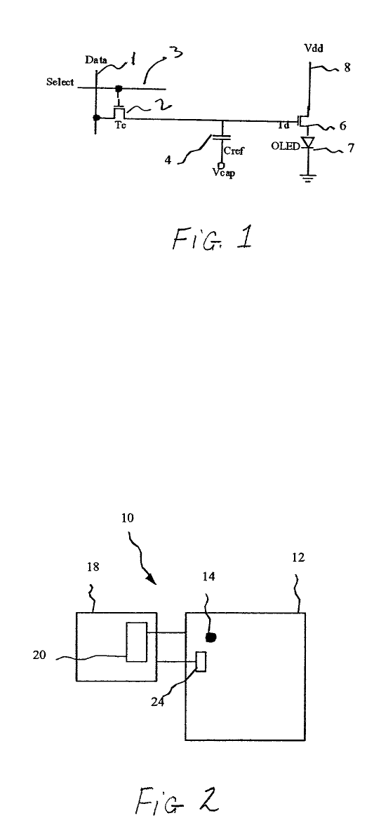

### DETAILED DESCRIPTION OF THE INVENTION

Flat-panel display devices degrade over time as they are used. In particular, the light emitting materials become less efficient resulting in a loss of brightness and accuracy in color rendition. For those flat-panel display devices for which the brightness of each light emitting element is voltage or current controlled, the present invention provides a system wherein a programmable power supply is used to modify the operational characteristics of the display device.

Referring to FIG. 2, a flat-panel display system 10 includes a flatpanel display 12 with light emitting elements 14, a display controller 18 having a programmable power supply 20, and a sensor 24. The sensor 24 detects the brightness of the light emitted or controlled at a light element 14 in the display and provides this information to the controller 18. The controller then programs the power supply 20 with the correct voltage or current parameters necessary to maintain the appropriate brightness from the light emitting elements 14.

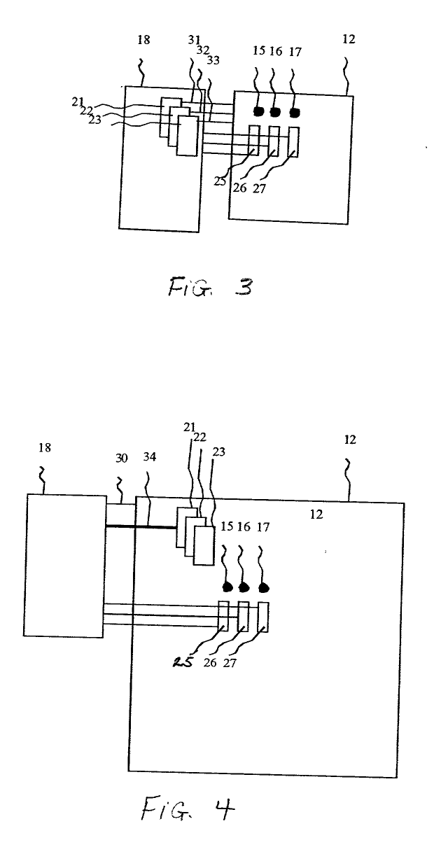

A more complex embodiment for use in color flat-panel devices is shown in FIG. 3, where separate sensors 25, 26 and 27 are shown for light emitting elements 15, 16 and 17. The sensors 25, 26 and 27 provide signals to the display controller 18. The controller programs the power supplies 21, 22 and 23 that then modify the operational characteristics of the light emitting elements within the display device through power lines 31, 32 and 33. Each of the light emitting elements 15-17 associated with the sensors 25-27 providing signals to the display controller 18 programming the power supplies 25-27 are each typically one of the colors of the display, for example, red, green, and blue. These sensors may generate separate signals applied to the controller over separate lines, or the signals may be multiplexed and supplied to the controller over a shared signal line.

As each of the light emitting elements changes over time, each of the power supplies driving the associated elements can be independently modified to provide the appropriate brightness consistent with maintaining the color balance of the device. For example, if the red elements become half as efficient, the power provided to the red elements can be increased as necessary to compensate, thus maintaining the original brightness and color balance. The ability of the present invention to compensate for changes in the efficiency of the light emitting elements is limited to the maximum power (voltage or current) each element can withstand. Hence, if, as in the previous example, the red elements cannot withstand a greater power, the green and blue power can be reduced to maintain a consistent color balance at the cost of brightness.

The components of the present invention may be implemented internally within a flat panel display, for example upon a common substrate or within a common package, or implemented externally in a separate integrated circuit or printed circuit board. In particular, the programmable power supplies may be implemented within common packaging or upon a common substrate as the flat-panel display to minimize the number of electrical leads necessary for the flat-panel display, as shown in FIG. 4. The individual power supplies can create their separate power sources from a common power source 30 provided to the flatpanel display. If the power for each separate set of elements is derived externally to the flat-panel package, a lead for each power supply is necessary.

If the power supply components are internal to the flat-panel device, they are readily accessible through address, data, and control lines 34 using conventional digital logic and analog power devices. If the components are external to the display device, conventional integrated circuit technology and packaging can be utilized to provide programmable voltage circuitry within the integrated circuit. Current and voltage control devices are well known in the prior art and are used in commercial products.

In a preferred embodiment, the invention is employed in a device that includes Organic Light Emitting Diodes (OLEDs) which are composed of small molecule polymeric OLEDs as disclosed in but not limited to U.S. Pat. No. 4,769,292, issued Sep. 6, 1988 to Tang et al. and U.S. Pat. No. 5,061,569, issued Oct. 29, 1991 to VanSlyke et al. Many combinations and variations of organic light emitting displays can be used to fabricate such a device.

The invention has been described in detail with particular reference to certain preferred embodiments thereof, but it will be understood that variations and modifications can be effected within the spirit and scope of the invention.

### Parts List

1 data line

2 transistor

3 select line

4 capacitor

6 transistor

7 organic light emitting diode

8 power supply

10 flat-panel display system

12 flat-panel display

14 light emitting element

15 colored light emitting element

16 colored light emitting element

17 colored light emitting element

18 display controller

20 programmable power supply

21 programmable power supply for group of color elements

22 programmable power supply for group of color elements

23 programmable power supply for group of color elements

24 sensor

25 sensor for color light emitting element

26 sensor for color light emitting element

27 sensor for color light emitting element

30 power lead

31 power lead for color elements

32 power lead for color elements

33 power lead for color elements

34 address data and control lines

What is claimed is:

1. An active matrix OLED flat-panel display, comprising:
a) a plurality of light emitting elements and associated control circuits;
b) a programmable power supply connected to the control circuits;
c) a sensor for sensing the light output of one or more light emitting elements to produce a feedback signal; and
d) a display controller responsive to the feedback signal for programming the programmable power supply to compensate for changes in the light output from the light emitting elements.

2. The display claimed in claim 1, wherein the display is a color display having light emitting elements for emitting different colors, and further comprising a separate sensor for each color emitted by the display.

3. The display claimed in claim 1, further comprising separate programmable power supplies for each color in the flat-panel display.

4. The display claimed in claim 1, wherein the programmable power supply is on a common substrate with the display.

5. The display claimed in claim 1, wherein the programmable power supply is on a separate substrate from the display.

6. The display claimed in claim 1, wherein the programmable power supply is in a common package with the display.

7. The display claimed in claim 1, wherein the programmable power supply is in a separate package from the display.

8. The display claimed in claim 1, wherein the programmable power supply is addressable as a storage element.

9. A method of controlling an active matrix OLED flat-panel display having a plurality of light emitting elements and associated control circuits, comprising the steps of:
a) providing a programmable power supply connected to the control circuits;
b) sensing the light output of one or more light emitting elements to produce a feedback signal; and
c) programming the programmable power supply in response to the feedback signal to compensate for changes in the light output from the light emitting elements.

10. The method claimed in claim 9, wherein the display is a color display having differently colored light emitting elements and further comprising the steps of providing a programmable power supply for each color, sensing the light output for each color and programming the respective power supplies in response to the respective feedback signals.

11. The method claimed in claim 9, wherein the display includes a controller having a lookup table for receiving device independent code values and producing device dependent code values and further comprising the step of calibrating the controller by changing the lookup table.

12. The method claimed in claim 9, wherein the display is a color display that includes a controller having a lookup table for receiving device independent code values and producing device dependent code values and further comprising the step of calibrating the controller by changing the lookup table to correct for the color balance of the display.
